(19) United States
(12) Patent Application Publication
(10) Pub. No.: US 2010/0123801 A1
(43) Pub. Date: May 20, 2010

(54) DIGITAL IMAGE PROCESSING APPARATUS AND METHOD OF CONTROLLING THE DIGITAL IMAGE PROCESSING APPARATUS

(75) Inventors: Sang-ryoon Son, Suwon-si (KR); Byeong-chan Park, Suwon-si (KR); Hyun-sik Yu, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/621,617

(22) Filed: Nov. 19, 2009

(30) Foreign Application Priority Data
Nov. 19, 2008 (KR) 10-2008-0115367

(51) Int. Cl. H04N 5/76; H04N 5/228; G06K 9/00

(52) U.S. Cl. 348/231.99; 348/222.1; 382/165; 348/E05.031

(57) ABSTRACT

Provided are a digital image processing apparatus capable of detecting faces of people on an input image and obtaining images captured based on different setting values for the faces, and a method of controlling the digital image processing apparatus. The method includes receiving an input image; detecting faces of people in the input image; detecting different skin colors of the faces; setting shooting conditions according to different skin colors of the faces detected on the input image; and capturing images based on the shooting conditions.

### CROSS-REFERENCE TO RELATED PATENT APPLICATION

This application claims the benefit of Korean Patent Application No. 10-2008-0115367, filed on Nov. 19, 2008 in the Korean Intellectual Property Office, the entire contents of which is incorporated herein by reference.

### BACKGROUND OF THE INVENTION

1. Field of the Invention

The present invention relates to a digital image processing apparatus and a method of controlling the digital image processing apparatus, and more particularly, to a digital image processing apparatus capable of processing an image based on different faces detected in the image, and a method of controlling the digital image processing apparatus.

2. Description of the Related Art

Digital image processing apparatuses include all apparatuses which process images or use image recognition sensors, for example, digital cameras, personal digital assistants (PDAs), phone cameras, or PC cameras.

A digital image processing apparatus may perform image processing and compression on an image input through an imaging device by using a digital signal processor (DSP), so as to generate an image file, and may store the image file in memory.

Also, the digital image processing apparatus may display an image input through the imaging device or an image of an image file stored in a storing medium, on a display device such as a liquid crystal display (LCD) device.

The quality of the captured images often determines the perceived quality of the digital image processing apparatus.

### SUMMARY OF THE INVENTION

According to an aspect of the present disclosure, there is provided a method of controlling a digital image processing apparatus, the method including receiving an input image; detecting faces of people on the input image; detecting skin colors of the faces; setting shooting conditions according to different skin colors of the faces detected in the input image; and capturing images based on the shooting conditions.

The setting of the shooting conditions and the capturing of the images may include setting the shooting conditions according to the skin colors; perform image capturing based on the shooting conditions; and determining whether image capturing is completed with respect to all of the faces detected on the input image.

If a plurality of faces are detected on the input image, the shooting conditions may be set according to each of the skin colors of all of the plurality of faces detected on the input image, and images separately corresponding to all of the shooting conditions may be captured.

The setting of the shooting conditions may include adjusting white balance gains according to the skin colors.

The setting of the shooting conditions may include adjusting exposure values according to the skin colors.

The method may further include grouping the faces into a plurality of face types according to the face colors, and the detecting of the skin colors may include recognizing each of the faces as one of the plurality of face types.

The setting of the shooting conditions may include setting the shooting conditions which are preset according to the face types.

According to another aspect of the present invention, there is provided a method of controlling a digital image processing apparatus, the method including receiving an input image; detecting faces of people on the input image; detecting skin colors of the faces; generating transformed images by performing image processing based on processing conditions according to different skin colors of the faces; and obtaining images by using the transformed images.

The method may further include setting a shooting condition of the input image; and generating a captured image by capturing the input image.

The detecting of the faces may include detecting the faces of the people on the captured image.

The input image may be read from a previously stored image file.

If a plurality of faces are detected on the input image, the processing conditions may be set according to each of the skin colors of all of the plurality of faces detected on the input image, and the transformed images may be generated by performing image processing based on each of the processing conditions.

The generating of the transformed images may include performing image processing based on the processing conditions according to the skin colors; and determining whether image processing is completed with respect to all of the faces detected on the input image.

The method may further include grouping the faces into a plurality of face types according to the face colors, and the detecting of the skin colors may include recognizing each of the faces as one of the plurality of face types.

The performing of image processing may include performing image processing based on the processing conditions which are preset according to the face types.

According to another aspect of the present invention, there is provided a digital image processing apparatus including an image input unit for receiving an input image; a storage for storing shooting conditions according to skin colors of faces of people; and a control unit for controlling the digital image processing apparatus to detect the faces on the input image, to detect the skin colors of the faces, to set the shooting conditions according to each of the skin colors of the faces detected on the input image, and to capture images based on the shooting conditions.

If a plurality of faces are detected on the input image, the shooting conditions may be set according to each of the skin colors of all of the plurality of faces detected on the input image, and images separately corresponding to all of the shooting conditions may be captured.

The shooting conditions may be white balance gains or exposure values.

The faces may be grouped into a plurality of face types according to the face colors, and the shooting conditions which are preset according to the face types may be stored in the storage.

Each of the faces may be recognized as one of the plurality of face types.

According to another aspect of the present invention, there is provided a digital image processing apparatus including an image input unit for receiving an input image; a storage for storing processing conditions according to skin colors of faces of people; and a control unit for controlling the digital image processing apparatus to detect the faces on the input image, to detect the skin colors of the faces, to generate transformed images by performing image processing based on the processing conditions according to each of the skin colors of the faces, and to obtain images by using the transformed images.

A captured image may be generated by capturing the input image, and the faces of the people are detected on the captured image.

The input image may be read from an image file which is previously stored in the storage.

If a plurality of faces are detected on the input image, the processing conditions may be set according to each of the skin colors of all of the plurality of faces detected on the input image, and the transformed images may be generated by performing image processing based on each of the processing conditions.

The faces may be grouped into a plurality of face types according to the face colors, the processing conditions which are preset according to the face types may be stored in the storage, and each of the faces may be recognized as one of the plurality of face types.

### BRIEF DESCRIPTION OF THE DRAWINGS

The above and other features and advantages of the present disclosure will become more apparent by describing in detail exemplary embodiments thereof with reference to the attached drawings in which:

FIG. 1 is a rear view of an example of a digital camera as an example of a digital image processing apparatus;

FIG. 2 is a block diagram of an example of a control apparatus included in the digital camera illustrated in FIG. 1;

FIG. 3 is a block diagram of an example of a digital image processing apparatus;

FIG. 4 is a flowchart of an example of a method of controlling a digital image processing apparatus, according to an embodiment of the present invention;

FIG. 5 is a flowchart of an example of a method of controlling a digital image processing apparatus, according to another embodiment of the present invention; and

FIG. 6 shows an example of an input image including faces of people.

### DETAILED DESCRIPTION OF THE INVENTION

Hereinafter, the present disclosure will be described in detail by explaining embodiments of the disclosure with reference to the attached drawings.

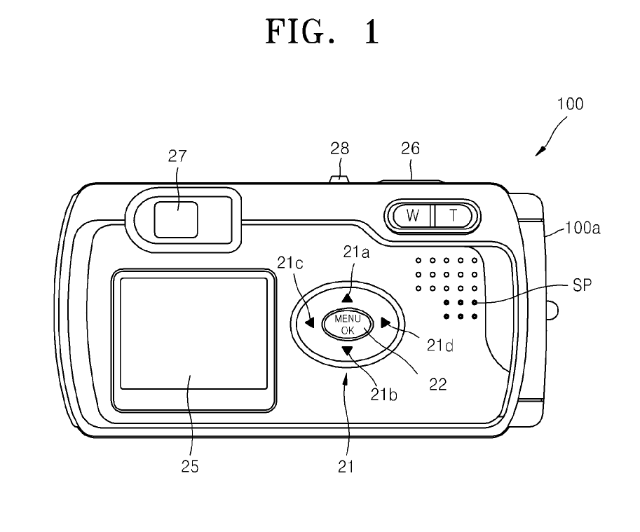

FIG. 1 is a rear view of an example of a digital camera 100 as an example of a digital image processing apparatus according to an embodiment of the present invention.

Referring to FIG. 1, a direction button 21, a menu-OK button 22, a wide-zoom button W, a tele-zoom button T, and a display panel 25 may be disposed on a rear surface of the digital camera 100.

The direction button 21 may include four buttons such as an up button 21A, a down button 21B, a left button 21C, and a right button 21D. The direction button 21 and the menu-OK button 22 are input keys for executing a variety of menus regarding operations of the digital camera 100.

As the wide-zoom button W or the tele-zoom button T is pressed, a view angle is widened or narrowed. In particular, the wide-zoom button W or the tele-zoom button T may be used to change the size of a selected exposed area. In this case, if the wide-zoom button W is pressed, the size of the selected exposed area may increase, and if the tele-zoom button T is pressed, the size of the selected exposed area may decrease.

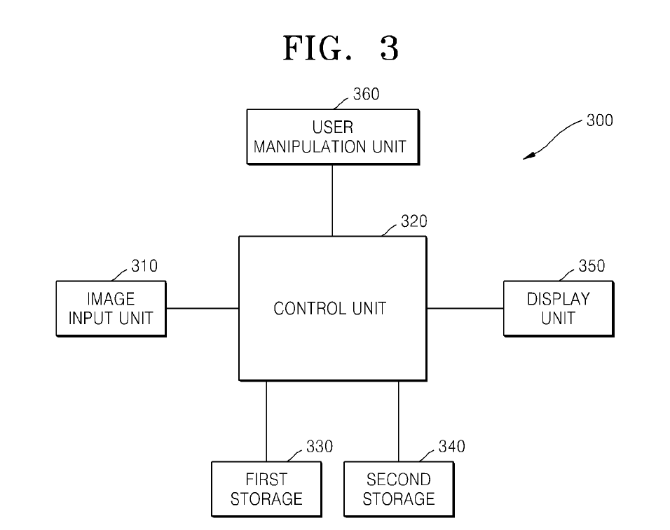

Embodiments of the display panel 25 include, but are not limited to, image display devices such as a liquid crystal display (LCD) device. The display panel 25 may be included in a display unit (see 350 in FIG. 3) for displaying a live view of an input image.

A shutter release button 26, a flash (not shown), a power switch 28, and a lens unit (not shown) may be disposed on a front surface or a top surface of the digital camera 100. Also, a subject lens (not shown) and an ocular lens (not shown) of a viewfinder 27 may be disposed on the front and rear surfaces of the digital camera 100.

The shutter release button 26 and the power switch 28 may be included in a user manipulation unit (see 360 in FIG. 3) through which a user inputs a desired manipulation signal from outside the digital camera 100.

The shutter release button 26 opens or shuts a shutter in order to expose a film or an imaging device such as a charge-coupled device (CCD) to light for a predetermined period of time. Also, the shutter release button 26 may generate a signal for the digital camera to record an image on the imaging device by appropriately exposing a subject in cooperation with an iris (not shown).

The shutter release button 26 may be half-pressed or full-pressed. If the shutter release button 26 is half-pressed, a first signal S1 may be generated, and if the shutter release button 26 is full-pressed, a second signal S2 may be generated. Thus, image capturing is prepared by the first signal S1 and is performed by the second signal S2.

An example of a digital camera is disclosed in U.S. Patent Publication No. 20040130650 entitled “Method of automatically focusing a quadratic function in camera”, filed by the present applicant, the entire contents of which are hereby included by reference.

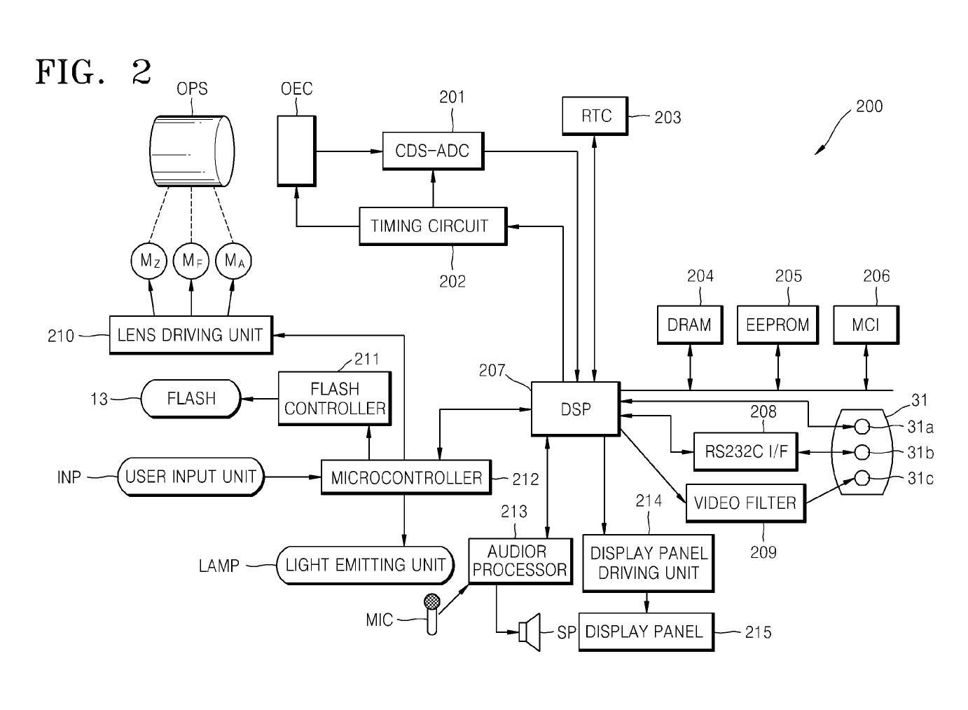

FIG. 2 is a block diagram of a control apparatus 200 of a digital image processing apparatus, according to an embodiment of the present invention. The control apparatus 200 may be included in the digital camera 100 illustrated in FIG. 1 and thus FIG. 2 will be described in conjunction with FIG. 1.

Referring to FIG. 2, an optical system OPS, including a lens unit and a filter unit, optically processes light from a subject. The lens unit of the optical system OPS includes a zoom lens, a focus lens, and a compensation lens. If a user presses the wide-zoom button W or the tele-zoom button T included in a user input unit INP, a corresponding signal is input to a microcontroller 212.

Accordingly, the microcontroller 212 controls a lens driving unit 210 to drive a zoom motor M_{Z}, thereby moving the zoom lens. If the wide-zoom button W is pressed, a focal length of the zoom lens is reduced and thus a view angle is widened, and if the tele-zoom button T is pressed, the focal length of the zoom lens is increased and thus the view angle is narrowed.

In an auto-focusing mode, a main controller included in a digital signal processor (DSP) 207 controls the lens driving unit 210 through the microcontroller 212 to drive a focus motor M_{F}. The focus lens may be moved to a position where the clearest image can be obtained, by driving the focus motor M_{F}.

The compensation lens compensates for an overall refractive index and thus is not separately driven. Also, an aperture motor M_{A} drives an aperture (not shown).

In the filter unit of the optical system OPS, an optical low pass filter removes optical noise of a high frequency component. An infrared cut filter cuts off an infrared component of incident light.

A photoelectric conversion unit OEC may include an imaging device such as a CCD and a complementary metal-oxide-semiconductor (CMOS) device. The photoelectric conversion unit OEC converts light received from the optical system OPS into an analog electric signal.

An analog-digital conversion unit may include a correlation double sampler and analog-to-digital converter (CDS-ADC) device 201. The analog-digital conversion unit processes an analog signal received from the photoelectric conversion unit OEC to remove high frequency noise from and to adjust the amplitude of the analog signal, and then, converts the analog signal into a digital signal. In this case, the DSP 207 controls a timing circuit 202 to control operations of the photoelectric conversion unit OEC and the analog-digital conversion unit.

The optical system OPS, the photoelectric conversion unit OEC, and the CDS-ADC device 201 may be included in an image input unit (see 310 in FIG. 3).

A real-time clock (RTC) 203 provides time information to the DSP 207. The DSP 207 processes the digital signal received from the CDS-ADC device 201 to generate a digital image signal defined by a luminance (Y) signal and chromaticity (R, G, B) signals.

A light emitting unit LAMP driven by the microcontroller 212 that controlled by the main controller included in the DSP 207 may include a self-timer lamp, an auto-focusing lamp, a mode indication lamp, and a flash standby lamp. The user input unit INP may include the direction button 21, the wide-zoom button W, and the tele-zoom button T. Also, the user input unit INP may be included in a user manipulation unit (see 360 in FIG. 3).

An electrically erasable and programmable read only memory (EEPROM) 205 stores setting data and algorithms such as a booting program and a key input program which are required to operate the DSP 207. The EEPROM 205 may store information required for face recognition, shooting information regarding detected faces, and shooting information regarding skin colors, as a database.

The DSP 207 and/or the microcontroller 212 may be included in a control unit (see 320 in FIG. 3). Also, the DSP 207 and/or the microcontroller 212 may include a cache memory as a temporary storage. A dynamic random access memory (DRAM) 204 temporarily stores the digital image signal received from the DSP 207.

In this case, the cache memory and the DRAM 204 may be included in a first storage (see 330 in FIG. 3) for temporarily storing an input image. The cache memory may be included in the first storage instead of in the DSP 207 and/or the microcontroller 212.

A memory card of the user may be attached to or detached from a memory card interface (MCI) 206. The memory card, which is recognized with the MCI 206, is a non-volatile memory for storing images captured based on different shooting conditions with respect to the same image, and may be included in a second storage (see 340 in FIG. 3).

The digital image signal received from the DSP 207 is input to a display panel driving unit 214 that drives a display panel 215 to display an image on the display panel 215.

The control apparatus 200 may further include a display unit including the display panel 215 and the display panel driving unit 214 for driving the display panel 215. The display panel driving unit 214 and the display panel 215 may be included in a display unit (see 350 in FIG. 3).

Meanwhile, the digital image signal received from the DSP 207 may be transmitted as a serial communication signal through a universal serial bus (USB) connection unit 31A or an RS232C interface 208 and its connection unit 31B, or may be transmitted as a video signal through a video filter 209 and a video output unit 31C. Here, the DSP 207 may include the microcontroller 212.

An audio processor 213 outputs a voice signal received from a microphone MIC to the DSP 207 or a speaker SP and an audio signal received from the DSP 207 to the speaker SP.

The control apparatus 200 may further include a flash 13 and a flash controller 211 for controlling the flash 13.

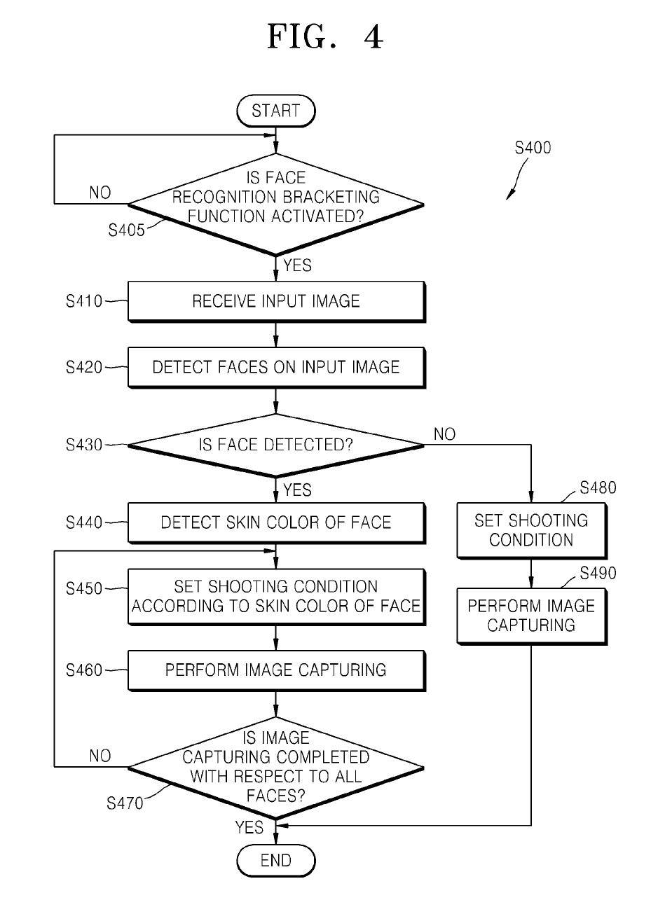

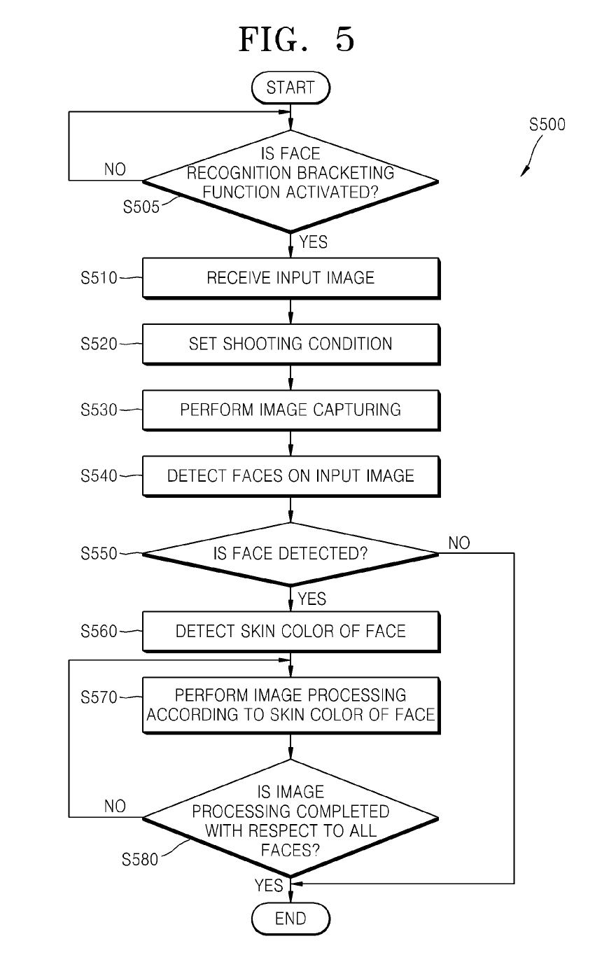

FIG. 3 is a block diagram of an example of a digital image processing apparatus 300 according to an embodiment of the present invention. The digital image processing apparatus 300 may be controlled by a control method such as the example control methods of FIGS. 4 and 5.

Referring to FIG. 3, the digital image processing apparatus 300 may include an image input unit 310, a control unit 320, first and second storages 330 and 340, a display unit 350, and a user manipulation unit 360.

The image input unit 310 receives an input image. The first and second storages 330 and 340 store shooting conditions according to skin colors of faces of people. The control unit 320 controls the digital image processing apparatus 300 to detect faces on the input image, to detect skin colors of the faces, to set shooting conditions according to different skin colors of the faces detected in the input image, and to capture images based on the shooting conditions.

If a plurality of faces are detected on the input image, the digital image processing apparatus 300 may set the shooting conditions according to different skin colors of the faces detected in the input image, and then capture images separately corresponding to the different shooting conditions. A composite image of the images can then be made. The digital image processing apparatus 300 may select which faces in the input image to set the shooting conditions for and capture an image based on the shooting conditions. For example, if five faces are detected in the image, the digital image processing apparatus 300 may select two faces based on the size of the faces and the proximity of the faces to a focus region. The digital image processing apparatus 300 may select which faces to capture separate images for based on different criteria, which may include, but is not limited to, the size of the faces, the proximity of the faces to a focus region, a number of faces set by a user settings, and the number of faces that need the same shooting conditions. In an embodiment, the digital image processing apparatus 300 will capture an image with the shooting conditions set for each of the faces. The faces may be grouped into a plurality of face types according to the skin colors, and the shooting conditions may be separately set according different face types. The shooting conditions for different face types according to the skin colors may be stored in the first and second storages 330 and 340 as a database, and a shooting condition based on a face type according to each of the skin colors may be retrieved from the database.

The shooting conditions, which are previously set according to the face types, may be set to the detected faces. The shooting conditions that may be set for the different skin colors include, but are not limited to, white balance gains, and exposure values.

Alternatively, the digital image processing apparatus 300 may perform image processing for a detected face rather than capturing an image with different shooting conditions for the face. The first and second storages 330 and 340 may store the shooting conditions according to the skin colors of the faces of the people, the control unit 320 may control the digital image processing apparatus 300 to detect faces in the input image, to detect skin colors of the faces, to generate transformed images by performing image processing based on processing conditions according to each of the skin colors of the faces, and to obtain images by using the transformed images.

The control unit 320 may capture the input image so as to obtain a captured image and may detect the faces on the captured image. Alternatively, the input image may be read from an image file that is previously stored in the first and second storages 330 and 340.

In embodiments, instead of capturing a plurality of images according to different skin colors of the faces detected in the input image, only one image may be captured and image processing may be performed on the image based on the processing conditions according to different skin colors of faces detected in the image. In embodiments, the digital image processing device 300 may capture a separate image for some skin colors and may process the image for other skin colors.

The digital image processing apparatus 300 may set processing conditions according to different skin colors of the faces detected in the input image, and generate the transformed images by performing image processing on portions of the image that contain the faces based on the different processing conditions.

The display unit 350 may display a live view of the input image. The image input unit 310 receives the input image from an external device. The image input unit 310 may include the optical system OPS, the photoelectric conversion unit OEC, and the CDS-ADC device 201 which are illustrated in FIG. 2.

The control unit 320 controls the image input unit 310, the first and second storages 330 and 340, the display unit 350, and the user manipulation unit 360 to detect the faces on the input image, to set shooting conditions according to each of the skin colors of the faces detected on the input image, and to capture the images based on the shooting conditions. The control unit 320 may include the DSP 207 and/or the microcontroller 212 which are illustrated in FIG. 2.

The first and second storages 330 and 340 may store the shooting conditions according to different skin colors, the input image, and the captured images. The first storage 330 may temporarily store the input image. The second storage 340 may store the shooting conditions according to different skin colors, and the captured image as a non-volatile image.

The display unit 350 may include the display panel 25 illustrated in FIG. 1 and/or the display panel driving unit 214 and the display panel 215 which are illustrated in FIG. 2. A user may input a desired instruction through the user manipulation unit 360 from outside the digital image processing apparatus 300. The user manipulation unit 360 may include the shutter release button 26 and the power switch 28 which are illustrated in FIG. 1 and/or the user input unit INP illustrated in FIG. 2.

Images appropriate for each of a plurality of people may be obtained by detecting faces of the people in an input image and setting different shooting values for the faces.

FIG. 4 is a flowchart of an example of a method S400 of controlling a digital image processing apparatus, according to an embodiment of the present invention.

The method S400 may be performed by the control apparatus 200 illustrated in FIG. 2 and the digital image processing apparatus 300 illustrated in FIG. 3. The method S400 may be stored in the EEPROM 205 illustrated in FIG. 2 as an algorithm or a program.

Referring to FIG. 4, the method S400 may include receiving an input image in operation S410; detecting faces in operation S420; detecting skin colors in operation S440; and capturing images in operations S450, S460, and S470.

An input image is received in operation S410. Faces of people are separately detected on the input image in operation S420. Skin colors of the faces are separately detected in operation S440. Images are captured by setting different shooting conditions according to different skin colors of the faces detected in the input image in operations S450, S460, and S470.

If a plurality of faces are detected on the input image, the shooting conditions may be set according to each of the skin colors of all of the faces detected in the input image and images separately corresponding to the different shooting conditions may be captured. However, the present invention is not limited thereto, and as discussed above, the digital image processing device 300 may set different shooting conditions and capture images for some of the faces. Additionally as discussed above, the digital image processing device 300 may perform image processing on some of the faces and set shooting conditions and capture a new image for other faces.

When the new images are captured, the shooting conditions are set in operation S450, image capturing is performed in S460, and it is determined whether image capturing is completed in operation S470.

The shooting conditions are set according to the skin colors in operation S450. Image capturing is performed based on the shooting conditions in operation S460. It is determined whether image capturing is completed with respect to all of the faces detected in the input image, in operation S470.

The digital image processing apparatus 300 may combine the different images either before or after operation S470. In addition, the digital image processing apparatus 300 may perform image processing on the image based on the different faces. In addition, the digital image processing apparatus 300 may combine the different images based on a user selecting which images to combine.

New images may be captured for each of the different colors of faces detected in the input image. Operations S450 and S460 may be repeated based on a whether there are more images to capture, in operation S470.

The method S400 may further include determining whether a face recognition function is activated, in operation S405. In an embodiment, only if it is determined that the face recognition function is activated in operation S405, will the method S400 be performed.

The face recognition function may be executed by operations S410, S420, S440, S450, S460, and S470.

Also, the digital image processing device 300 determines whether a face of a person is detected in the input image in operation S430. In embodiments, only if a face of a person is detected in the input image in operation S430, are operations S440, S450, S460, and S470 performed.

If a face of a person is not detected in the input image in operation S430, a typical shooting condition is set in operation S480 and the input image is captured based on the typical shooting condition in operation S490.

The faces may be grouped into a plurality of face types according to the different skin colors and the shooting conditions may be separately set according to the different face types. Operation S440 may include the digital image processing device 300 determining the type of a face, and retrieving shooting conditions based on the type of the face, which may be retrieved from a database. In operation 540 the digital image processing apparatus 300 may be set according to the retrieved shooting conditions.

For example, the shooting conditions set in operation S450 may be white balance gains that are differently set according to different skin colors.

White balance adjustment is performed to correct color distortion caused by a light source due to characteristics of an image sensor in the digital image processing apparatus. For this, a white balance gain may be calculated according to the input image and may be multiplied by each of the gray-scale values of red, green, and blue colors of the input image.

A preferred skin color of a face of a person may vary according to races and regions. Thus, when people having different skin colors, i.e., Caucasian, African, and Asian are photographed together, if white balance is adjusted based on a skin color of a specific person, skin colors of other people may have non-preferable colors.

Also, since the white balance varies according to light sources, a problem may occur when people are photographed under multiple light sources and thus the people are photographed as if they have different skin colors. For example, when people are photographed under multiple light sources, and thus an incandescent lamp influences one person and a fluorescent lamp influences another person, if the white balance is adjusted based on a skin color of a specific person, skin colors of other people may have non-preferable colors.

Accordingly, white balance gains may be set according to the skin colors and the white balance may be adjusted based on the white balance gains. In this case, the shooting conditions such as the white balance gains may be set based on another reference such as hair colors as well as the skin colors.

In this case, if faces of people are detected in the input image, the skin colors of the faces may be separately detected and images may be captured based on the shooting conditions according to different skin colors. Image capturing may be performed based on optimal white balance gains according to the face with a single shot. Thus, the face may have their own optimal images.

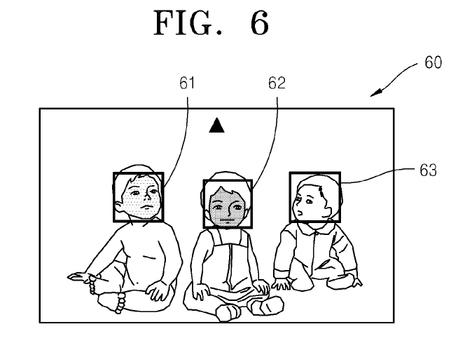

FIG. 6 shows an example of an input image 60 including faces of people.

The method S400 illustrated in FIG. 4 will now be described in more detail with reference to FIG. 6.

Referring to FIG. 6, the input image 60 may include, for example, three people. In this case, the input image 60 including three people is received in operation S 410.

The three faces of the people may be detected in the input image 60 in operation S420. If it is determined that a face of a person is detected in operation S430, skin colors may be separately detected in face areas 61, 62, 63 of the three people in operation S440.

If it is determined that a face of a person is not detected in operation S430, a typical shooting condition may be set in operation S480 and the input image may be captured based on the typical shooting condition in operation S490.

White balance adjustment is performed according to a skin color of one person in operation S450. Image capturing is performed according to a white balance gain set to the skin color of the person, in operation S460.

It is determined whether image capturing is completed with respect to all of the faces 61, 62, 63 detected on the input image 60, in operation S470. In this case, if it is determined that image capturing is not yet completed with respect to all of the faces 61, 62, 63 detected on the input image 60, operations S450 and S460 may be repeated for subsequent faces 61, 62, 63 of people. Thus, image capturing may be performed by varying the white balance gain with respect to the same image.

Operations S450 and S460 may be repeated until it is determined that image capturing is completed with respect to all of the faces 61, 62, 63 detected on the input image 60, in operation S470.

Alternatively, instead of the white balance gain, an exposure value that varies according to a detected skin color may be set as a shooting condition in operation S450. Exposure adjustment may be performed by setting the shooting condition such that image capturing is performed based on the exposure value set to the skin color of the face 61, 62, 63, in operation S450.

Exposure adjustment is performed to control elements regarding brightness in the digital image processing apparatus by determining an appropriate exposure value of a face.

The appropriate exposure value of a face 61, 62, 63 may vary according to races and regions. Thus, when subjects having different skin colors, i.e., Caucasian, African, and Asian races are photographed together, if exposure is adjusted based on a skin color of a specific person, skin colors of other people may have non-preferable brightness levels.

Also, the appropriate exposure value may vary according to positions of subjects, i.e., under sunlight, in a shade, or in a building. Thus, a similar problem may occur if a plurality of subjects are located in multiple brightness levels of light. Exposure adjustment may be performed to set the appropriate exposure value by setting an aperture, a shutter speed, International Organization for Standardization (ISO) sensitivity, etc.

If the exposure value is set as the shooting condition to be determined according to a skin color in operation S450, the same method may be performed as a case when the white balance gain is set as the shooting condition.

Faces 61, 62, 63 of people may have their own optimal images by detecting faces 61, 62, 63 of the people in an input image, and obtaining images based on shooting conditions which are differently set according to skin colors of faces of the people.

The digital image processing apparatus 300 may group the faces 61, 62, 62 together in any combination and/or select only some of the faces 61, 62, 63 to capture new images for. For example, the digital image processing apparatus 300 may group faces 61 and 63 together and set different shooting conditions and then capture a new image for faces 61 and 63, and then combine the new image with the original image. The digital image processing apparatus 300 may set new shooting conditions and then capture another image for face 62, or it may perform digital image processing for the face 62, or it may simply not perform any particular action for face 62. The digital image processing apparatus 300 may combine the different images, and/or the digital image processing apparatus 300 may present to a user options for combining the different images.

FIG. 5 is a flowchart of an example of a method S500 of controlling a digital image processing apparatus, according to another embodiment of the present invention.

Referring to FIG. 5, the method S500 captures an input image and generates an image. The digital image processing apparatus may perform image processing on different face in the image based on the skin colors of the face.

Referring to FIG. 5, the method S500 may include receiving an input image in operation S510; detecting faces in operation S540; detecting skin colors in operation S560; and generating images in operations S570 and S580.

An input image is received in operation S510. Faces of people are separately detected in the input image in operation S540. Skin colors of the faces are separately detected in operation S560.

Transformed images are generated by performing image processing based on processing conditions according to different skin colors of the faces detected on the input image and images are obtained by using the transformed images, in operations S570 and S580. Image processing is performed in operation S570 and it is determined whether image processing is completed in operation S580. The digital image processing apparatus 300 combines the images.

If a plurality of faces are detected on the input image, processing conditions may be set according to different skin colors of faces detected in the input image, and the transformed images corresponding to each of the processing conditions may be generated by performing image processing based on each of the processing conditions.

A processing condition is set according to a skin color and image processing is performed based on the processing condition in operation S570. The digital image processing apparatus 300 determines whether image processing is completed with respect to all of the faces detected on the input image, in operation S580.

The method S500 may further include determining whether a face recognition function is activated, in operation S505. If it is determined that the face recognition function is activated in operation S505, the method S500 may be performed. The face recognition function may identify a region in the image where a face is detected. The region where the face is detected may be the region that is used to combine images and/or determine the area of the region to perform digital image processing on.

The face recognition function may be executed by operations S510, S540, S560, and S570 and S580.

A captured image may be generated by capturing the input image received in operation S510. For this, the method S500 may further include setting a shooting condition in operation S520 and generating a captured image by capturing the input image based on the shooting condition. In this case, the shooting condition may be, for example, a white balance gain or an exposure value which is applied when an image is typically captured. In this case, the faces of the people may be detected from the captured image in operation S540.

Alternatively, the input image may be read from among a plurality of previously stored images. In more detail, the input image is not limited to a currently captured image, and may be a previously captured and stored image or an image that is generated by and received from another digital image processing apparatus.

Also, it is determined whether a face of a person is detected on the input image in operation S550. If a face of a person is detected on the input image in operation S550, operations S560, S570, and S580 may be performed.

A transformed image may be generated by performing image processing based on the processing condition according to the skin color in operation S570. Operation S570 may be repeated for different faces until it is determined that image processing is completed with respect to all of the faces for which image processing is to be performed.

The faces may be grouped into a plurality of face types according to the skin colors and the processing conditions may be separately set according to the face types. In this case, operation S560 may include recognizing each of the faces as one of the face types, and image processing may be performed based on one of the processing conditions which are previously set according to the face types in operation S570.

For example, the processing conditions set in operation S570 may be white balance gains or exposure values which are differently set according to the skin colors.

Faces may have their own optimal images by detecting faces of the people in an input image, and obtaining images based on shooting conditions which are differently set according to skin colors of faces of the people.

The digital image processing apparatus 300 may perform image processing on any face or group of faces in the image and/or may capture a separate image(s) for any face or group of faces in the image. The digital image processing apparatus 300 may combine different images and/or perform image processing for different faces based on selections from a user.

The various illustrative units, logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

While the present disclosure has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of controlling a digital image processing apparatus, the method comprising:
receiving an input image;
detecting faces in the input image;
detecting skin colors of the faces;
setting shooting conditions according to different skin colors of the detected faces;
capturing images based on the different shooting conditions; and
combining the images.

2. The method of claim 1, wherein the setting of the shooting conditions and the capturing of the images comprise:
setting the shooting conditions according to the skin colors;
perform image capturing based on the shooting conditions; and
determining whether image capturing is completed with respect to all of the faces detected on the input image.

3. The method of claim 1, wherein, if a plurality of faces are detected on the input image, the shooting conditions are set according to at least two of the skin colors of all of the plurality of faces detected in the input image, and images separately corresponding to all of the shooting conditions are captured.

4. The method of claim 2, wherein the setting of the shooting conditions comprises adjusting white balance gains according to the skin colors.

5. The method of claim 2, wherein the setting of the shooting conditions comprises adjusting exposure values according to the skin colors.

6. The method of claim 2, further comprising grouping the faces into a plurality of face types according to the face colors, and
wherein the detecting of the skin colors comprises recognizing each of the faces as one of the plurality of face types.

7. The method of claim 6, wherein the setting of the shooting conditions comprises setting the shooting conditions which are preset according to the face types.

8. The method of claim 1, further comprising: generating transformed images by performing image processing based on processing conditions according to different skin colors of the faces;

9. A method of controlling a digital image processing apparatus, the method comprising:
receiving an input image;
detecting faces in the input image;
detecting skin colors of the faces;
generating transformed images by performing image processing based on processing conditions according to different skin colors of the faces; and
obtaining images by using the transformed images.

10. The method of claim 9, further comprising:
setting a shooting condition of the input image; and
generating a captured image by capturing the input image.

11. The method of claim 9, wherein the input image is read from a previously stored image file.

12. The method of claim 9, wherein, if a plurality of faces are detected in the input image, the processing conditions are set according to different skin colors of all of the plurality of faces detected on the input image, and the transformed images are generated by performing image processing based on different processing conditions.

13. The method of claim 9 further comprising:
setting shooting conditions according to different skin colors of the detected faces;
capturing images based on the different shooting conditions; and
combining the images.

14. The method of claim 9, wherein the generating of the transformed images comprises:
performing image processing based on the processing conditions according to the skin colors; and
determining whether image processing is completed with respect to all of the faces detected in the input image.

15. The method of claim 14, wherein the performing of image processing comprises adjusting white balance gains according to the skin colors.

16. The method of claim 14, wherein the performing of image processing comprises adjusting exposure values according to the skin colors.

17. The method of claim 14, further comprising grouping the faces into a plurality of face types according to the face colors, and
wherein the detecting of the skin colors comprises recognizing different faces as one of the plurality of face types.

18. The method of claim 14, wherein the performing of image processing comprises performing image processing based on the processing conditions which are preset according to the face types.

19. A digital image processing apparatus comprising:
an image input unit configured to receive an input image;
a storage configured to store shooting conditions according to skin colors of faces of people; and
a control unit configured to control the digital image processing apparatus to detect the faces on the input image, to detect the skin colors of the faces, to set the shooting conditions according to different skin colors of the faces detected in the input image, to capture images based on the shooting conditions, and to combine the images.

20. The digital image processing apparatus of claim 19, wherein, if a plurality of faces are detected on the input image, the shooting conditions are set according to different skin colors of all of the plurality of faces detected in the input image, and images separately corresponding to different shooting conditions are captured.

21. The digital image processing apparatus of claim 19, wherein the shooting conditions are white balance gains or exposure values.

22. The digital image processing apparatus of claim 19, wherein the faces are grouped into a plurality of face types according to the face colors, and
wherein the shooting conditions which are preset according to the face types are stored in the storage.

23. The digital image processing apparatus of claim 19, wherein faces are recognized as one of the plurality of face types.

24. The digital image processing apparatus of claim 19, wherein the control unit is further configure to generate transformed images by performing image processing based on the processing conditions according to different skin colors of the faces.

25. A digital image processing apparatus comprising:
an image input unit for receiving an input image;
a storage configured to store processing conditions according to different skin colors of faces; and
a control unit configured to detect the faces in the input image, to detect the skin colors of the faces, to generate transformed images by performing image processing based on the processing conditions according to different skin colors of the faces, and to obtain images by using the transformed images.

26. The digital image processing apparatus of claim 25, wherein a captured image is generated by capturing the input image, and the faces of the people are detected in the captured image.

27. The digital image processing apparatus of claim 25, wherein the input image is read from an image file which is previously stored in the storage.

28. The digital image processing apparatus of claim 25, wherein, if a plurality of faces are detected on the input image, the processing conditions are set according to different skin colors of faces detected in the input image, and the transformed images are generated by performing image processing based on each of the processing conditions.

29. The digital image processing apparatus of claim 25, wherein the processing conditions are white balance gains or exposure values.

30. The digital image processing apparatus of claim 25, wherein the faces are grouped into a plurality of face types according to the face colors,
wherein the processing conditions which are preset according to the face types are stored in the storage, and
wherein faces are recognized as one of the plurality of face types.
